(19) United States
(12) Patent Application Publication
(10) Pub. No.: US 2005/0076516 A1
(43) Pub. Date: Apr. 14, 2005

(54) Cookie cutter and method of making same

(75) Inventors: William A. Groll, McMurray, PA (US); John Milnthorp, McMurray, PA (US)

Correspondence Address: WEBB ZIESENHEIM LOGSDON ORKIN & HANSON, P.C., 700 KOPPERS BUILDING, 436 SEVENTH AVENUE, PITTSBURGH, PA, 15219, US

(73) Assignee: Signature Art Ware

(21) Appl. No.: 10/683,375

(22) Filed: Oct. 10, 2003

(51) Int. Cl. B26B 3/00

(52) U.S. Cl. 30/315

(57) ABSTRACT

A cookie cutter comprising (a) a silhouette formed in a desired shape and carrying a dough cutting shape at a front face; (b) a plaque formed to conform with the shape of the silhouette and positioned at a rear face of said silhouette, said plaque having an outer surface and an inner surface; and (c) a polymeric adhesive material positioned on an inside surface of the plaque and joining the silhouette and plaque together.

### BACKGROUND OF THE INVENTION

1. Field of the Invention

The present invention relates to the design and construction of cookie cutters of superior durability and aesthetic appeal. In particular, its unique construction provides a large flat surface which can be marked with text or artwork. This makes the article particularly useful as a promotional monogrammed item or as simply a kitchen utensil that is also an attractive decoration. The invention also relates to methods of making cookie cutters.

2. Description of Related Art

Cookie cutters are made of a wide range of materials including stainless steels, copper, plated steel, aluminum, and plastic. Their function is to simply cut a recognizable silhouette from rolled-out cookie dough. Most cookie cutters are inexpensive and are made from very light materials and are subject to damage or distortion during use or storage. One popular design is made by roll forming one edge of a strip of steel, and then cutting the strip to length and welding the two ends together to form a ring. The ring is placed into a multi-slide press such as a spring forming press and is bent into a shape. The roll formed edge helps retain the formed shape and provides a non-sharp edge to press against the hand when the cookie cutter is in use. These are simple, functional and inexpensive but are easily crushed or distorted if not handled and stored with great care. Although this design is not durable, the tooling and production are low cost and highly flexible over a wide range of shapes. It is not effective, however, on larger size cookie cutters, which tend to become very weak and distort easily.

Another popular cookie cutter is the plastic injection molded type. These are very low cost to manufacture but require a considerable up-front investment in designing and machining the mold tooling. Plastic cookie cutters are sold at a very low retail price and tend to be offered in sets such as the shapes or letters or numbers or animals. These, too, are functional for cutting dough but not adaptable to specialized marketing and, again, are not durable.

Aluminum cookie cutters have been deep drawn for many years. These feature a shape silhouette to cut dough but also have a solid top, which provides a good location to grip. The solid top also makes the drawn aluminum cookie cutters substantially stronger and far more crush resistant. Because of the nature of deep drawn parts, the range of shapes available with the aluminum cookie cutter is severely limited. And like the plastic molded type, these are very expensive to tool for production.

### SUMMARY OF THE INVENTION

The present invention has been conceived to create a cookie cutter which is sturdy, durable, easy to clean, easy to use, aesthetically pleasing and easily adapted to specialty shapes. Its construction features a flat top surface which can be marked with texts such as recipes or holiday greetings or with illustrations. Briefly stated, the cookie cutter of my invention comprises a silhouette formed in a desired shape and carrying a dough-cutting shape at a front face; a plaque formed to conform with the shape of the silhouette and positioned at a rear face of said silhouette; and a polymeric adhesive material positioned on an inside surface of the plaque and joining the silhouette and plaque together.

### BRIEF DESCRIPTION OF THE DRAWINGS

FIG. 1A is a perspective view of a formed ring in the first manufacturing step of the present invention;

FIG. 1B is a silhouette formed into a desired shape using the formed ring of FIG. 1B in a multi-sided press;

FIG. 1C is the finished silhouette shape of FIG. 1B;

FIG. 2 depicts the tracing of the silhouette of FIG. 1C onto a plaque portion of the cookie cutter of the invention;

FIG. 3 is a perspective view of a jig for use in making the cookie cutter of the invention;

FIG. 4 is a cross-sectional view of the cookie cutter;

FIGS. 5A and 5B depict a wall-mounted holder for holding and displaying several exemplary cookie cutter shapes of the present invention.

### DETAILED DESCRIPTION OF THE INVENTION

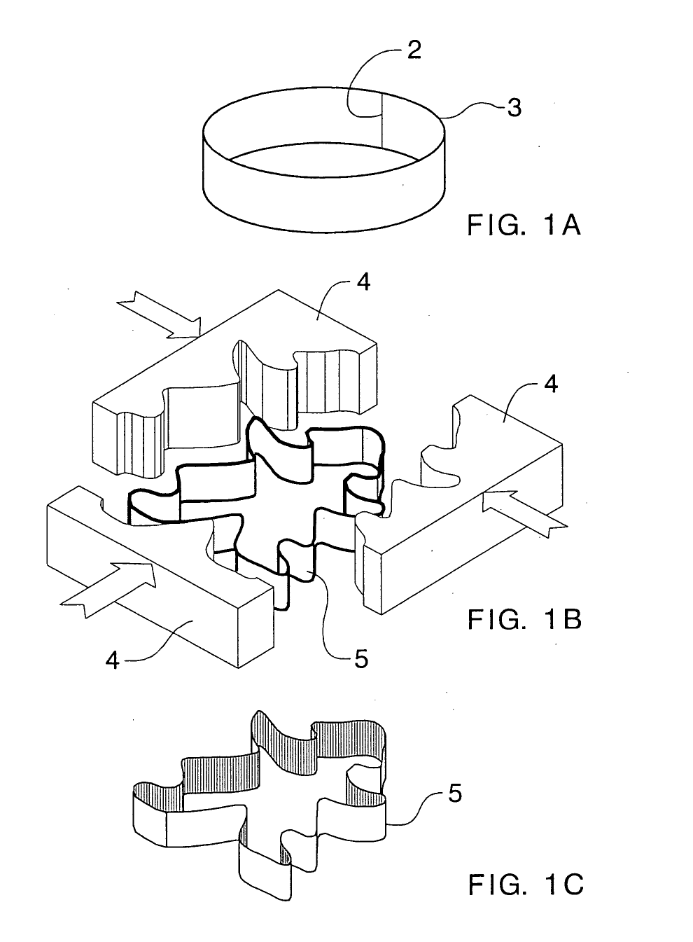

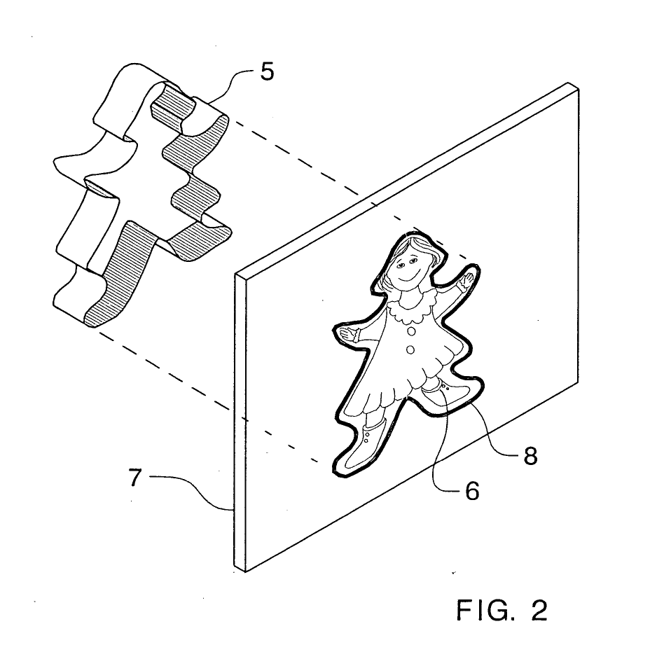

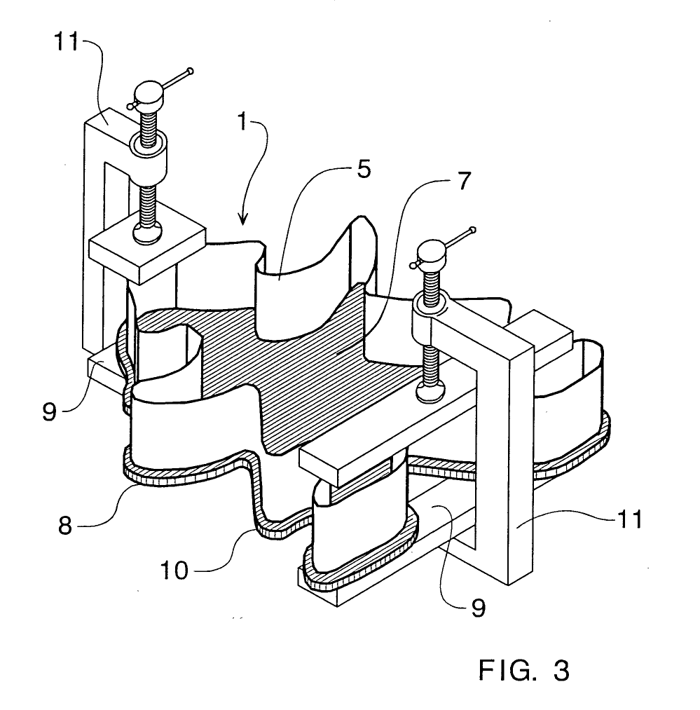

Referring to FIG. 1A, a strip of metal is cut to a predetermined length and the two ends are welded together at 2 to form a ring 3. This ring 3 does not need to have a roll formed edge. The width of the strip can range from ½″ to 2″ and the thickness can range from 0.010″ to 0.100″. The ring 3 is inserted into a multi-sided type press with horizontally sliding, pre-shaped dies 4 and bent into a silhouette 5 (FIG. 1B) by inward movement of the dies 4. The silhouette 5 formed from the metal ring 3 is shown in FIG. 1C in the outline of a young girl. The multi-side tooling arrangement shown in FIG. 1B depicts three sliding dies 4; however, it will be understood that other die arrangements can be employed, for example, up to eight slidable dies 4 can be used to form more intricate shapes for the silhouette 5. The silhouette 5 is then traced and the tracing is used as a template to cut a flat piece of material such as wood, metal or plastic (FIG. 2). The cut image 8 can be slightly larger than the actual silhouette 5 but not smaller. The cut piece of flat material 7 is placed face down on a horizontal surface 9 and the metal silhouette 5 is placed on top of it (FIG. 3). The flat material will hereafter be referred to as the “plaque” portion 10 of the cookie cutter 1.

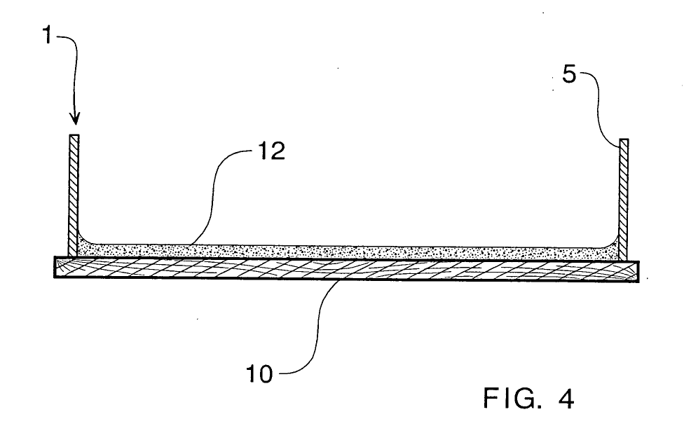

The silhouette 5 and the plaque 10 are now clamped together using a clamping tool 11 and a continuous layer of a polymeric material or polymer 12 such as a food grade polymer adhesive is cast into the cup formed by the clamped silhouette and plaque (FIG. 4). The food grade polymer 12 (such as EP4000, Marsh Laboratories) should contact 100% of the surface area of the back side of the plaque 10 and 100% of the edge of the silhouette 5, which is adjacent to the plaque. The assembly remains clamped in clamping tool 11 for the recommended cure time for the selected polymer 12. The plaque 10 may be marked with text or artwork before or after the assembly process. The above method of manufacture may also be used with a silhouette ring 3 of any material, which will adhere to the food grade polymer, including a wide range of metals, plastics, glass, or ceramics. The polymer 12 used should be of a viscosity that is self-leveling and can penetrate the joint between the silhouette and plaque. The clamping process should be tight enough to prevent the free flow of polymer to the outside of the assembly.

The table below comprises characteristics
of various cookie cutters:

| | | Formed | Drawn | Ring & |
|---|---|---|---|---|
| | Molded Plastic | Metal | Aluminum | Plaque |
| Functionality | Good | Good | Good | Good |
| Comfort to hold | Fair | Fair | Good | Good |
| Crush strength | Poor | Poor | Fair | Good |
| Cost to Manufacture | Low | Low | Medium | High |
| Tooling Costs | High | Low | High | Low |
| Flexibility of shapes | Fair | Good | Poor | Good |
| Text and illustration | N/A | N/A | Poor | Good |
| Larger shapes | Poor | Poor | Fair | Good |

The cookie cutter made by the method of the present invention provides the following desirable characteristics:
(1) Strength—Will not distort with use or storage.
(2) The plaque 10 provides a safe and comfortable grip. The plaque also forces the cutting edge of the utensil to conform to a flat plane, making it easy to use.
(3) The assembly does not involve a roll formed edge. The roll formed edge may present cleanliness issues.
(4) The top surface of the plaque 10 offers an opportunity to work with text or illustration. This may be done by processes such as laser marking, silk screening, rubber stamping, block printing, or decaling. This feature allows the cookie cutter to function as a greeting card, recipe card or decorative home ornament in addition to its basic intended function of cutting cookie dough into desired shapes.
(5) The method of construction of the invention allows for the cookie cutter to be made much larger than by other available methods. These can be made large enough to cut sheet cakes into custom shapes.

### EXAMPLE

A strip of stainless steel which is 0.020″ thick, 1″ wide and 15″ long was made into a ring 3 by welding the two ends together at weld bend 2. The ring 3 was formed into a silhouette 5 of a bell shape (not shown) on a multi-slide press. A piece of basswood, measuring ⅛″ thick, 3″ wide and 4″ long, was cut into the shape of a bell forming the plaque 10. A laser marking system was used to cut the wood and mark the surface of the wood with a holiday greeting phrase. The wood plaque 10 was placed on a horizontal surface with the text facing down, and the bell-shaped silhouette 5 was placed on the back surface of the plaque 10 so that the perimeters of the wood plaque 10 and silhouette 5 closely matched. The two pieces were clamped together and a food grade polymer 12 was poured into the metal silhouette 10 to a depth of approximately 0.050″. The polymer 12 sealed the surface of the wood plaque 10 and formed a filet joint to the steel around the perimeter. The resulting cookie cutter 1 provided a sturdy, attractive item which is appealing for its decorative nature and highly functional as a kitchen utensil. The cookie cutter 1 doubles as a holiday ornament or can be sent as a greeting.

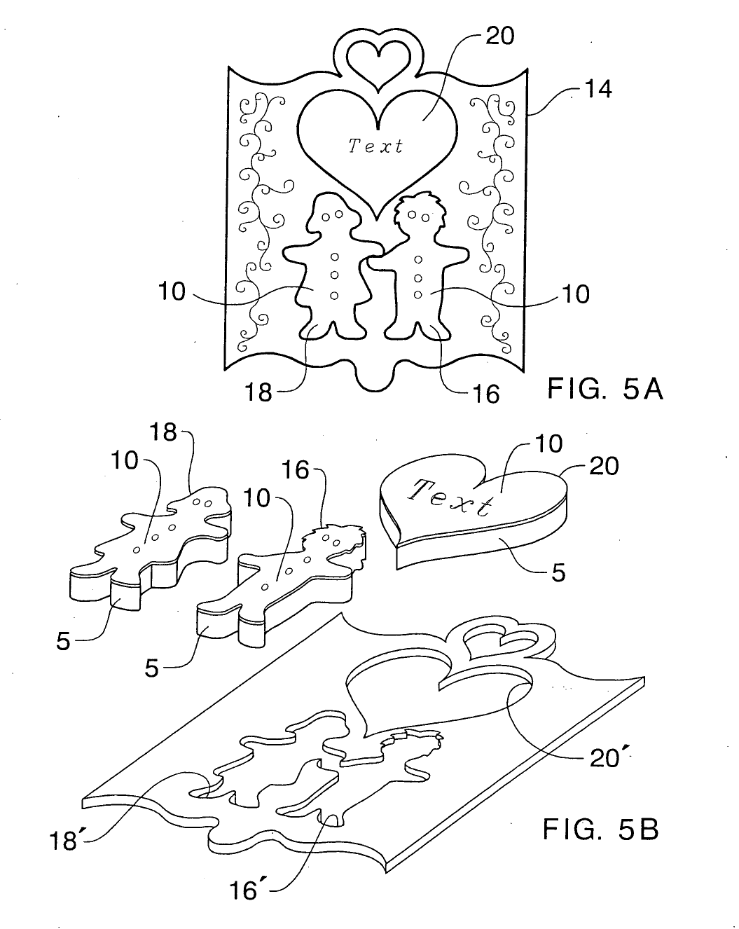

A further embodiment of the present invention is depicted in FIGS. 5A and 5B. A decorative wall-mounted cookie cutter holder 14 is shown with three cookie cutters 16, 18 and 20 of the invention mounted therein. The cookie cutters 16 and 18 are respectively formed in the shapes of a young boy and a young girl and the cookie cutter 20 is formed in the shape of a heart. The boy and girl cookie cutters 16 and 18 have decorative markings in the form of eyes and buttons formed on the plaque portion 10 of each while the heart-shaped cookie cutter 20 has text inscrib4ed thereon, all done by laser, for example. As shown in FIG. 5B, the wall-mounted holder 14 has cut-out portions 16′, 18′ and 20′ formed therein to closely receive and hold the respective cookie cutters 16, 18 and 20 for mounting and display as depicted in FIG. 5A.

While specific embodiments of the invention have been described in detail, it will be appreciated by those skilled in the art that various modifications and alternatives to those details could be developed in light of the overall teachings of the disclosure. The presently preferred embodiments described herein are meant to be illustrative only and not limiting as to the scope of the invention which is to be given the full breadth of the appended claims and any and all equivalents thereof.

1. A cookie cutter comprising:
(a) a silhouette formed in a desired shape and carrying a dough cutting shape at a front face;
(b) a plaque formed to conform with the shape of the silhouette and positioned at a rear face of said silhouette, said plaque having an outer surface and an inner surface; and
(c) a polymeric adhesive material positioned on an inside surface of the plaque and joining the silhouette and plaque together.

2. The cookie cutter of claim 1 wherein the plaque carries decorative indicia on the outer surface.

3. The cookie cutter of claim 1 wherein the plaque has a peripheral edge that extends outwardly from the silhouette defining a gripping means for grasping the cookie cutter.

4. The cookie cutter of claim 1 wherein the silhouette is made from stainless steel and the plaque is made from wood and the polymer adhesive material is a food grade polymer.

5. The cookie cutter of claim 4 wherein the plaque has decorative indicia formed thereon by one of laser marking, stamping, engraving and decal.

6. The cookie cutter of claim 1 including, in combination, a wall-mounted holder having a cut-out portion of a shape matching the shape of the cookie cutter for holding and displaying the cookie cutter therein.

7. A method of making a cookie cutter comprising the steps of:
(a) providing a strip of material;
(b) forming a ring from said strip;
(c) welding ends of the ring together;
(d) forming the ring in a multi-slide press into a silhouette of a desired shape;
(e) forming a plaque in a configuration at least as large as the shape of the silhouette;
(f) placing the plaque on the silhouette and clamping said plaque and silhouette together;
(g) pouring a polymeric adhesive material on a face of said plaque to cover said face and an edge periphery of said silhouette and curing said adhesive to join the plaque and silhouette;
(h) removing said clamp after the curing step; and
(i) applying decorative indicia to an outer face of said plaque, said applying step being optionally made at any step of said method.
